(19) United States
(12) Patent Application Publication
(10) Pub. No.: US 2009/0139488 A1
(43) Pub. Date: Jun. 4, 2009

(54) Diagnostic system for high pressure fuel system

(75) Inventors: James W. Harris, Galveston, IN (US); Sean P. Oilar, Wolcott, IN (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/987,517

(22) Filed: Nov. 30, 2007

(51) Int. Cl. F02M 69/46; G01M 15/04

(52) U.S. Cl. 123/456; 123/458

(57) ABSTRACT

A diagnostic system for an engine is disclosed. The diagnostic system has a sensor configured to sense a parameter of the fuel pressurized by the engine, and to generate a signal corresponding to a value of the parameter. The diagnostic system also has a controller in communication with the engine and the sensor. The controller is configured to detect a positive change in the parameter of the pressurized fuel and to inhibit starting of the engine if the positive change is not detected.

### TECHNICAL FIELD

The present disclosure is directed to a diagnostic system and, more particularly, to a diagnostic system for a high pressure fuel system.

### BACKGROUND

Common rail fuel systems typically employ multiple fuel injectors connected to a common rail that is provided with high pressure fuel. These fuel injectors can be selectively actuated to inject precise quantities of fuel at precise timings into combustion chambers of an associated engine. In order to produce these precise injection events, it can be important to know the pressure of the fuel within the common rail just prior to the injection events. For example, during engine start-up, the pressure in the common rail needs to be high enough to provide fuel flow sufficient for the injection event and, information about the fuel pressure within the common rail can drive displacement and/or delivery control of an associated fuel pump. Fuel pressure information can also be used to calculate a start of injection timing and an injection duration that results in the desired injection event. This fuel pressure information may be provided by a pressure sensor associated with the common rail.

During operation of the common rail fuel system and at engine start-up, it is possible for the pressure sensor to malfunction or for the fuel system to develop a severe leak. If the pressure sensor malfunctions, an electronic control module associated with the engine can indicate that the rail pressure is less than desired. As a result, the electronic control module will request full fuel flow, which can place an excessive load on the fuel pump, especially at low engine speeds, causing the pump to fail. This condition may also activate an associated rail pressure relief valve and shorten its life. Similarly, a severe leak could also result in a low rail pressure signal being sent by the control module to the pump, thereby causing continued leakage when pressure does not increase due to a breach in the fuel system. Thus, a strategy may be desired to improve the likelihood that the pressure sensor is operating appropriately and to protect fuel system components and/or the installation in the event of sensor failure or a severe leak in the fuel system.

One such strategy is described in U.S. Pat. No. 6,234,148 (the '148 patent) issued to Hartke et al. on May 22, 2001. The '148 patent describes a method for monitoring a pressure sensor, which determines a pressure in a pressure accumulator regulated by a pressure actuator. The '148 patent calculates an expected pressure value in the pressure accumulator for a given point in time based on a holding pressure preset by the pressure actuator and based on a detected rate of change in a mass balance of a medium contained within the pressure accumulator. The '148 patent further determines a pressure value in the pressure accumulator with the pressure sensor at the given point in time and compares the expected pressure value to the determined pressure value. If the pressure values deviate from each other beyond a predetermined amount, the pressure sensor is determined to be malfunctioning.

Although the method of the '148 patent may help detect if a pressure sensor is malfunctioning, it may be slow and lack applicability. For example, during engine start-up, it may be desirable to rapidly ascertain whether the fuel system is functioning properly to avoid damaging the pump, and the method employed by the '148 patent may be too slow to be applicable during engine start-up. In addition, the method of the '148 patent may require an algorithm sophisticated enough to carry out the process, which may be computationally expensive and slow to complete. Furthermore, the method of the '148 patent does not provide a mechanism to protect the system in the event the pressure sensor is malfunctioning.

The disclosed diagnostic system may be directed at overcoming one or more of the problems set forth above.

### SUMMARY

One aspect of the present disclosure is directed to a diagnostic system for an engine. The diagnostic system includes a sensor configured to sense a parameter of fuel pressurized by the engine and to generate a signal corresponding to the value of the parameter. The diagnostic system further includes a controller in communication with the engine and the sensor. The controller is configured to detect a positive change in the parameter of the pressurized fuel based on the signal and to inhibit engine starting if the positive change is not detected.

Another aspect of the present disclosure is directed to a method of controlling a fuel system. The method includes pressurizing a supply of fuel and sensing a parameter of the pressurized fuel. The method further includes detecting a positive change in the parameter of the pressurized fuel and inhibiting engine starting if the positive change is not detected.

### BRIEF DESCRIPTION OF THE DRAWINGS

FIG. 1 is a schematic and diagrammatic illustration of an exemplary disclosed fuel system diagnostic system; and

FIG. 2 is a flow chart illustrating an exemplary disclosed method of operating the fuel system diagnostic system of FIG. 1.

### DETAILED DESCRIPTION

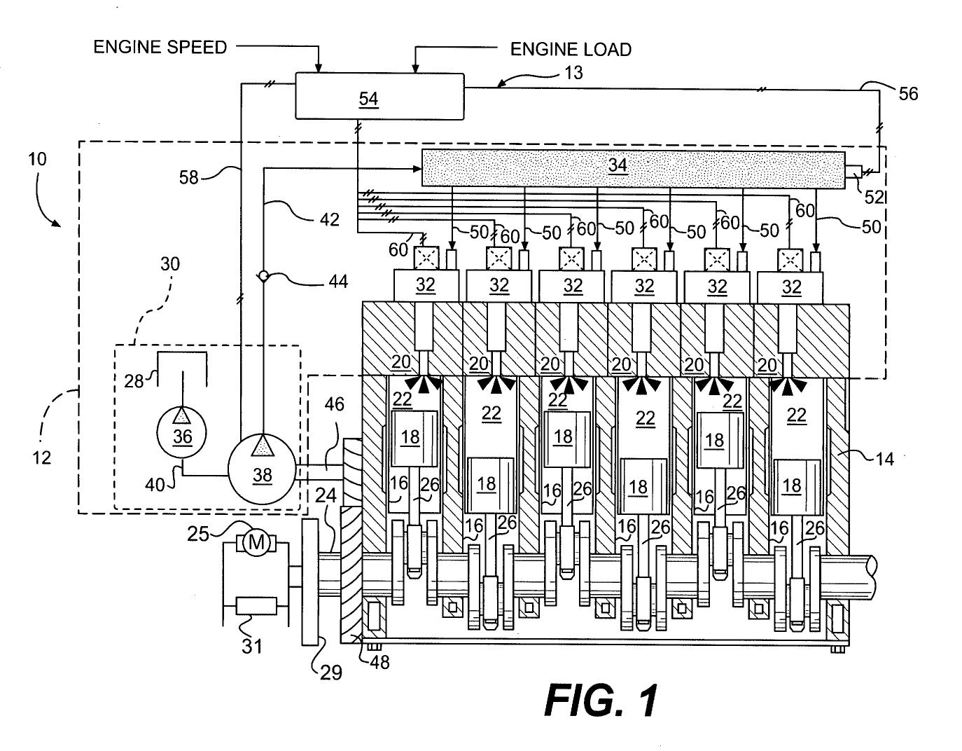

An exemplary embodiment of an engine 10 having a fuel system 12 and an associated diagnostic system 13 is illustrated in FIG. 1. For the purposes of this disclosure, engine 10 is depicted and described as a four-stroke diesel engine having a typical cycle consisting of an intake stroke, a compression stroke, a power stroke, and an exhaust stroke. One skilled in the art will recognize, however, that engine 10 may be any other type of internal combustion engine such as, for example, a gasoline engine or a gaseous fuel-powered engine. Engine 10 may include an engine block 14 having a plurality of cylinders 16, a piston 18 slidably disposed within each cylinder 16, and a cylinder head 20 associated with each cylinder 16.

Cylinder 16, piston 18, and cylinder head 20 may form a combustion chamber 22. In the illustrated embodiment, engine 10 includes six combustion chambers 22. However, it is contemplated that engine 10 may include a greater or lesser number of combustion chambers 22 and that combustion chambers 22 may be disposed in an “in-line” configuration, a “V” configuration, or any other suitable configuration.

As also shown in FIG. 1, engine 10 may include a crankshaft 24 that is rotatably disposed within engine block 14. A connecting rod 26 may connect each piston 18 to crankshaft 24 so that a sliding motion of piston 18 within each respective cylinder 16 results in a rotation of crankshaft 24. Similarly, a rotation of crankshaft 24 may result in a sliding motion of piston 18.

Fuel system 12 may include components that cooperate to deliver injections of pressurized fuel into each combustion chamber 22. Specifically, fuel system 12 may include a tank 28 configured to hold a supply of fuel, and a fuel pumping arrangement 30 configured to pressurize the fuel and direct the pressurized fuel to a plurality of fuel injectors 32 by way of a common rail 34.

Fuel pumping arrangement 30 may include one or more pumping devices that function to increase the pressure of the fuel and direct one or more pressurized streams of fuel to common rail 34. In one example, fuel pumping arrangement 30 may include a low pressure source 36 and a high pressure source 38 disposed in series and fluidly connected by way of a fuel line 40. Low pressure source 36 may be a transfer pump configured to provide low pressure feed to high pressure source 38. High pressure source 38 may be configured to receive the low pressure feed and to increase the pressure of the fuel up to about 300 MPa. High pressure source 38 may be connected to common rail 34 by way of a fuel line 42. A check valve 44 may be disposed within fuel line 42 to provide for a unidirectional flow of fuel from fuel pumping arrangement 30 to common rail 34.

Both of low and high pressure sources 36, 38 may each embody any suitable type of pump known in the art. For example, low and high pressure sources 36, 38 may each embody a fixed displacement pump having a movable sleeve that meters pressurized fuel from one or more axial pistons, a variable displacement pump having a swash plate that is angularly oriented to control output, a fixed delivery pump having a pressure control valve, or any other appropriate type of pump. One or both of low and high pressure sources 36, 38 may be selectively controlled to generate a desired pressure and/or flow rate of fuel within common rail 34.

One or both of low and high pressure sources 36, 38 may be operably connected to engine 10 and driven by crankshaft 24. Low and/or high pressure sources 36, 38 may be connected with crankshaft 24 in any manner readily apparent to one skilled in the art where a rotation of crankshaft 24 will result in a corresponding rotation of a pump drive shaft. For example, a pump driveshaft 46 of high pressure source 38 is shown in FIG. 1 as being connected to crankshaft 24 through a gear train 48. It is contemplated, however, that one or both of low and high pressure sources 36, 38 may alternatively be driven electrically, hydraulically, pneumatically, or in any other appropriate manner.

Fuel injectors 32 may be disposed within cylinder heads 20 and connected to receive pressurized fuel from common rail 34 by way of a plurality of fuel lines 50. Each fuel injector 32 may be operable to inject an amount of pressurized fuel into an associated combustion chamber 22 at predetermined timings, fuel pressures, and fuel flow rates. It is contemplated that fuel injectors 32 may be hydraulically operated, mechanically operated, electrically operated, pneumatically operated, or operated in any other suitable manner.

The timing of fuel injection into combustion chamber 22 may be synchronized with the motion of piston 18. For example, fuel may be injected as piston 18 nears a top-dead-center position in a compression stroke to allow for compression-ignited-combustion of the injected fuel. Alternatively, fuel may be injected as piston 18 begins the compression stroke heading towards a top-dead-center position for homogenous charge compression ignition operation. Fuel may also be injected as piston 18 is moving from a top-dead-center position towards a bottom-dead-center position during an expansion stroke for a late post injection to create a reducing atmosphere for aftertreatment regeneration.

Diagnostic system 13 may include components that cooperate with other systems to control operation of high pressure source 38 and/or fuel injectors 32 in response to one or more inputs. In particular, diagnostic system 13 may include one or more sensors 52 operably associated with common rail 34, and a controller 54.

Sensor 52 may be a pressure sensor configured to sense a pressure of the fuel within common rail 34 and to generate a signal indicative of the pressure. It is contemplated that sensor 52 may alternatively sense a different or additional parameter of the fuel within common rail 34 such as, for example, a temperature, a viscosity, a flow rate, or any other parameter known in the art.

Controller 54 may embody a single microprocessor or multiple microprocessors that include a means for controlling an operation of fuel system 12. Numerous commercially available microprocessors can be configured to perform the functions of controller 54. It should be appreciated that controller 54 could readily embody in a general engine microprocessor capable of controlling numerous engine functions. Controller 54 may include a memory, a secondary storage device, a processor, and other components for running an application. Various other circuits may be associated with controller 54 such as power supply circuitry, signal conditioning circuitry, solenoid driver circuitry, and other types of circuitry.

Controller 54 may be configured to receive the signal generated by sensor 52 and to determine if there is a positive change in the sensed parameter. In particular, controller 54 may be in communication with sensor 52 via a communication line 56 to receive the signal. A positive change may include an increase in pressure or flow rate within common rail 34 that corresponds with an increase in pump output.

Controller 54 may inhibit rotation of crankshaft 24 if the positive change is not detected and the engine is in start-up mode by, for example, inhibiting operation of a starter motor 25 and/or limiting fuel flow to common rail 34. Flow to common rail 34 may be limited by interrupting power supply to pump arrangement 30 or inhibiting flow to high pressure source 38. Starter motor 25 may be coupled to rotate engine 10 by way of crankshaft 24. For example, an output shaft (not shown) of starter motor 25 may be connected to provide rotational power through a coupling means 29 to drive crankshaft 24. Starter motor 25 may rely on a battery of engine 10 or, alternatively, may have a dedicated power source 31. It is to be appreciated that more than one starter motor 25 may be included to provide a desired degree of cranking capacity (e.g., torque), reliability, and/or redundancy. Similarly, starter motor 25 may employ a plurality of electrical, hydraulic, or pneumatic power sources, if desired. Controller 54 may inhibit operation of starter motor 25 by blocking starter motor 25 from receiving power, such as, for example, by disabling power source 31.

Controller 54, in combination with other sensors, may be further configured to control an output of high pressure source 38. In particular, controller 54 may be in communication with high pressure source 38 via a communication line 58. Controller 54 may be configured to determine whether engine 10 is increasing in speed and/or power output (i.e. ramping up) and to ensure that the pressure and/or flow rate of fuel within the common rail 34 is also increasing by an expected amount, especially during engine start-up.

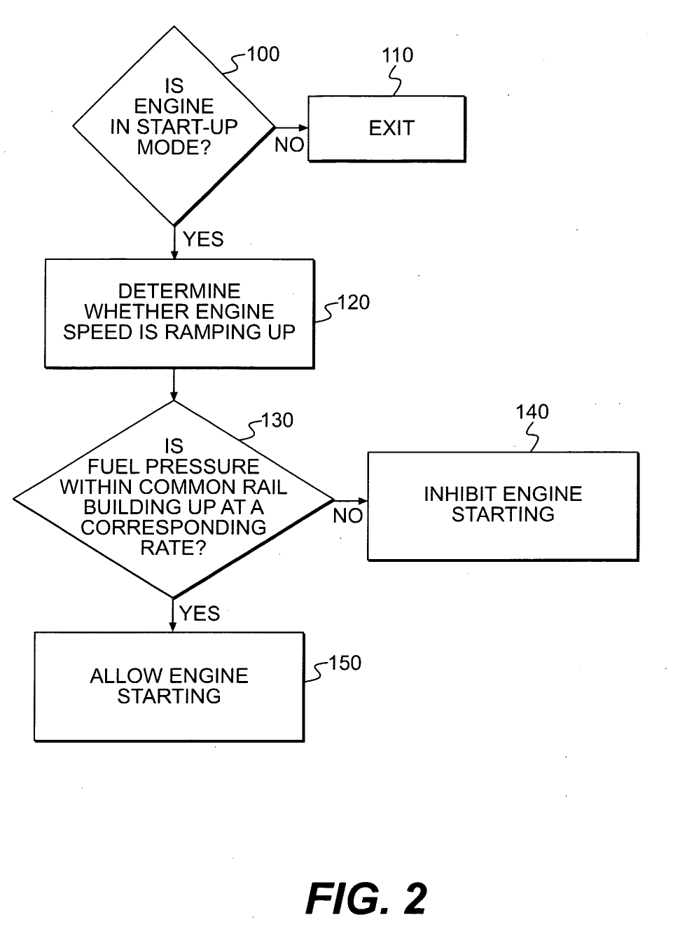

FIG. 2 illustrates an exemplary method of operating fuel system 12. FIG. 2 will be described in detail in the following section.

### INDUSTRIAL APPLICABILITY

The diagnostic system of the present disclosure may have wide application in a variety of engine types including, for example, diesel engines, gasoline engines, and gaseous fuel powered engines. The disclosed invention may be implemented into any engine that utilizes a pressurizing fuel system having common rail fuel injectors, where knowing the pressure of the fuel in the common rail is important for controlling operation of and protecting the fuel system. Operation of fuel system 12 and diagnostic system 13 will now be explained.

As illustrated in FIG. 2, implementing a desired injection may begin with controller 54 ascertaining whether engine 10 is in start-up mode. (step 100). If engine 10 is not in start-up mode, controller 54 may exit operation of diagnostic system 13. (step 110). If engine 10 is in start-up mode, controller 54 may determine whether engine speed is ramping up. (step 120). That is, controller 54 may ascertain whether crankshaft 24 is increasing in rotational speed and/or increasing in power output during the start-up mode of operation. Controller 54 may then determine whether or not fuel pressure within common rail 34 is building up at a corresponding rate (step 130) during the ramp up time period by determining whether a positive change has been detected. For example, controller 54 may ascertain, based on signals from sensors 52, whether fuel pressure within rail 34 is increasing. Alternatively, controller 54 may ascertain whether a flow rate of fuel passing though rail 34 is increasing.

Based on the determination made in step 120, controller 54 may selectively inhibit cranking of engine 10. (step 140). That is, if controller 54 does not detect a positive change in sensor 52 and engine 10 is in start-up mode, controller 54 may inhibit engine starting. (step 140). If engine 10 is in start-up mode and positive change is detected, controller 54 may allow engine starting to proceed. (step 150).

Controller 54 may disable engine cranking or limit flow through high pressure source 38 to prevent damage to pumping arrangement 30. That is, if positive change is not detected, engine 10 may request full fuel flow assuming the rail pressure is less than desired. This condition can place an excessive load on pumping arrangement 30, especially at low engine speeds and cause damage to pumping arrangement 30. Controller 54 may inhibit engine starting by interrupting power supply to starter motor 25 that drives crankshaft 24 during start-up and/or limiting flow through high pressure source 38. Controller 54 may limit flow through high pressure source 38 by limiting flow through low pressure source 36 or interrupting power supply to pumping arrangement 30, thereby, inhibiting operation of pumping arrangement 30. It should be noted that even if controller 54 inhibits engine starting, engine 10 may still be manually cranked by controller 54 or other mechanisms in, for example, emergency situations, if desired.

Controller 54 may not detect a positive change during start-up, if sensor 52 has malfunctioned or if there is a severe leak in fuel system 12 preventing the pressure from rising high enough for sensor 52 to detect a positive change. For example, a positive change may be present, but the change may be miniscule compared to an expected positive change, which would cause controller 54 to not detect the positive change. Under this condition, controller 54 would disable engine starting or limit injectors 32 to a single injection.

By relying, for example, only on whether pressure and/or flow rate within common rail 34 is increasing, the disclosed system may be quick and simple. Further, because injectors 32 may be limited to a single injection per piston cycle during the condition where a positive change is not detected and the engine is not in start-up mode, potential damage to engine 10 may be minimized.

It will be apparent to those skilled in the art that various modifications and variations can be made to the fuel system of the present disclosure without departing from the scope of the disclosure. Other embodiments will be apparent to those skilled in the art from consideration of the specification and practice of the fuel system disclosed herein. It is intended that the specification and examples be considered as exemplary only, with a true scope of the invention being indicated by the following claims and their equivalents.

What is claimed is:

1. A diagnostic system for an engine, comprising:
a sensor configured to sense a parameter of a fuel pressurized by the engine and to generate a signal corresponding to a value of the parameter; and
a controller in communication with the engine and the sensor, the controller being configured to detect a positive change in the parameter of the pressurized fuel and to inhibit engine starting if the positive change is not detected.

2. The diagnostic system of claim 1, wherein the controller is configured to detect the positive change during engine start-up.

3. The diagnostic system of claim 1, wherein the parameter is pressure.

4. The diagnostic system of claim 1, wherein the parameter is flow rate.

5. The diagnostic system of claim 1, further including at least one starter motor configured to crank the engine during start up, wherein the controller is configured to inhibit engine starting by inhibiting operation of the at least one starter motor.

6. The diagnostic system of claim 1, further including a high pressure source configured to pressurized the fuel, wherein the controller is configured to inhibit engine starting by limiting flow of the pressurized fuel through the high pressure source.

7. The diagnostic system of claim 6, wherein the flow of the pressurized fuel through the high pressure source is limited by inhibiting operation of a pumping arrangement.

8. A method of controlling a fuel system, the method comprising:
pressurizing a supply of fuel;
sensing a parameter of the pressurized fuel;
detecting a positive change in the parameter of the pressurized fuel; and
inhibiting engine starting if the positive change is not detected.

9. The method of claim 8, wherein detecting includes detecting the positive change during engine start-up.

10. The method of claim 8, wherein the parameter is pressure.

11. The method of claim 8, wherein the parameter is flow rate.

12. The method of claim 8, wherein inhibiting engine starting includes interrupting power supply to a starter motor.

13. The method of claim 8, wherein inhibiting engine starting includes limiting flow of the pressurized fuel to a common rail.

14. The method of claim 8, wherein inhibiting engine starting includes interrupting power supply to a starter motor and limiting flow of the pressurized fuel to a common rail.

15. An engine, comprising:
an engine block forming a plurality of cylinders;
a plurality of pistons associated with the plurality of cylinders to form a plurality of combustion chambers;
a source of pressurized fuel;
a rail configured to receive the pressurized fuel;
a plurality of fuel injectors in parallel fluid communication with the rail and configured to deliver injections of fuel into the plurality of combustion chambers;
a sensor configured to sense a parameter of the pressurized fuel within the rail and to generate a signal corresponding to a value of the parameter; and
a controller in communication with the source of pressurized fuel and the sensor, the controller being configured to detect a positive change in the parameter of the pressurized fuel and to inhibit engine starting if the positive change is not detected.

16. The engine of claim 15, wherein the controller is configured to detect the positive change during engine start-up.

17. The engine of claim 15, wherein the parameter is pressure.

18. The engine of claim 15, wherein the parameter is flow rate.

19. The engine of claim 15, wherein the controller is configured to limit flow of the pressurized fuel through a high pressure source to a common rail.

20. The engine of claim 15, further including at least one starter motor configured to crank the engine during start up, wherein the controller is configured to inhibit engine starting by inhibiting operation of the at least one starter motor.
